(19) United States
(12) Patent Application Publication
(10) Pub. No.: US 2014/0260245 A1
(43) Pub. Date: Sep. 18, 2014

(54) VOLUMETRIC ENERGY RECOVERY DEVICE WITH VARIABLE SPEED DRIVE

(71) Applicant: Eaton Corporation, Cleveland, OH (US)

(72) Inventor: William Nicholas Eybergen, Harrison Township, MI (US)

(73) Assignee: Eaton Corporation, Cleveland, OH (US)

(21) Appl. No.: 14/216,105

(22) Filed: Mar. 17, 2014

Related U.S. Application Data
(60) Provisional application No. 61/791,348, filed on Mar. 15, 2013.
(60) Provisional application No. 61/787,834, filed on Mar. 15, 2013.

(51) Int. Cl. F02B 73/00

(52) U.S. Cl. CPC F02B 73/00
USPC 60/624

(57) ABSTRACT

A volumetric expander configured to transfer a working fluid and generate useful work via a variable drive system is disclosed. The expander includes an inlet port configured to admit relatively high-pressure working fluid and an outlet port configured to discharge to a relatively low-pressure working fluid. The expander also includes first and second twisted meshed rotors rotatably disposed in the housing and configured to expand the relatively high-pressure working fluid into the relatively low-pressure working fluid. Each rotor has a plurality of lobes, and when one lobe of the first rotor is leading with respect to the inlet port, one lobe of the second rotor is trailing with respect to the inlet port. The expander additionally includes an output shaft coupled to the variable speed drive that can deliver power from the output shaft to the engine and/or to a load storage device.

### TECHNICAL FIELD

This application claims priority to U.S. Provisional Patent Application Ser. No. 61/791,348, filed Mar. 15, 2013, the entirety of which is incorporated by reference herein. This application claims also priority to U.S. Provisional Patent Application Ser. No. 61/787,834, filed Mar. 15, 2013, the entirety of which is incorporated by reference herein.

### TECHNICAL FIELD

The present disclosure relates to a volumetric fluid expander used for power generation in the Rankine cycle.

### BACKGROUND

The Rankine cycle is a power generation cycle that converts thermal energy to mechanical work. The Rankine cycle is typically used in heat engines, and accomplishes the above conversion by bringing a working substance from a higher temperature state to a lower temperature state. The classical Rankine cycle is the fundamental thermodynamic process underlying the operation of a steam engine.

In the Rankine cycle a heat “source” generates thermal energy that brings the working substance to the higher temperature state. The working substance generates work in the “working body” of the engine while transferring heat to the colder “sink” until the working substance reaches the lower temperature state. During this process, some of the thermal energy is converted into work by exploiting the properties of the working substance. The heat is supplied externally to the working substance in a closed loop, wherein the working substance is a fluid that has a non-zero heat capacity, which may be either a gas or a liquid, such as water. The efficiency of the Rankine cycle is usually limited by the working fluid.

The Rankine cycle typically employs individual subsystems, such as a condenser, a fluid pump, a heat exchanger such as a boiler, and an expander turbine. The pump is frequently used to pressurize the working fluid that is received from the condenser as a liquid rather than a gas. Typically, all of the energy is lost in pumping the working fluid through the complete cycle, as is most of the energy of vaporization of the working fluid in the boiler. This energy is thus lost to the cycle mainly because the condensation that can take place in the turbine is limited to about 10% in order to minimize erosion of the turbine blades, while the vaporization energy is rejected from the cycle through the condenser. On the other hand, the pumping of the working fluid through the cycle as a liquid requires a relatively small fraction of the energy needed to transport the fluid as compared to compressing the fluid as a gas in a compressor.

A variation of the classical Rankine cycle is the Organic Rankine cycle (ORC), which is named for its use of an organic, high molecular mass fluid, with a liquid-vapor phase change, or boiling point, occurring at a lower temperature than the water-steam phase change. As such, in place of water and steam of the classical Rankine cycle, the working fluid in the ORC may be a solvent, such as n-pentane or toluene. The ORC working fluid allows Rankine cycle heat recovery from lower temperature sources such as biomass combustion, industrial waste heat, geothermal heat, solar ponds, etc. The low-temperature heat may then be converted into useful work, which may in turn be converted into electricity.

### SUMMARY

A volumetric or positive displacement expander configured to transfer a working fluid and generate useful work includes a housing. The housing includes an inlet port configured to admit relatively high-pressure working fluid and an outlet port configured to discharge relatively low-pressure working fluid. The expander also includes first and second twisted meshed rotors rotatably disposed in the housing and configured to expand the relatively high-pressure working fluid into the relatively low-pressure working fluid. Each rotor has a plurality of lobes, and when one lobe of the first rotor is leading with respect to the inlet port, one lobe of the second rotor is trailing with respect to the inlet port. The expander additionally includes an output shaft coupled to a variable speed drive that can deliver power from the output shaft to the engine and/or to a load storage device.

Another embodiment of the disclosure is directed to a system used to generate useful work via a closed-loop Rankine cycle, wherein the system includes the volumetric expander described above.

Yet another embodiment of the disclosure is directed to a vehicle including a power-plant and employing the above system to augment the power generated by the power-plant.

The above features and advantages, and other features and advantages of the present disclosure, will be readily apparent from the following detailed description of the embodiment(s) and best mode(s) for carrying out the described invention when taken in connection with the accompanying drawings and appended claims.

### BRIEF DESCRIPTION OF THE DRAWINGS

FIG. 1 is a schematic depiction of a vehicle and power plant system employing an expander and variable speed drive having features that are examples of aspects in accordance with the principles of the present disclosure.

FIG. 2 is a schematic perspective top view of an expander used in the system shown in FIG. 1.

FIG. 3 is a schematic cross-sectional side view of the expander shown in FIG. 2.

FIG. 4 is a diagram depicting the Rankine cycle employed by the system shown in FIG. 1.

FIG. 5 is a schematic depiction of the system shown in FIG. 1 being used in a vehicle having an internal combustion (IC) engine as a vehicle power-plant.

FIG. 6 is a schematic depiction of the system shown in FIG. 1 being used in a vehicle having a fuel cell as a vehicle power-plant.

FIG. 7 is a side view of a configuration of an expander usable in the system shown in FIG. 12.

FIG. 8 is a cross-sectional view of the expander shown in FIG. 7 taken along the axial centerline of the expander.

FIG. 9 is a schematic showing geometric parameters of the rotors of the expander shown in FIG. 7.

FIG. 10 is a schematic cross-sectional view of the expander shown in FIG. 7.

FIG. 11 is a schematic view of a variable speed drive for use with the expander shown in FIG. 2.

FIG. 12 is a schematic depiction of a system employing a Rankine cycle for generating useful work and having features that are examples of aspects in accordance with the principles of the present disclosure.

### DETAILED DESCRIPTION

Referring to the drawings wherein like reference numbers correspond to like or similar components throughout the several figures. FIGS. 1-12 illustrate a system in which a volumetric energy recovery device 20 having dual interleaved twisted rotors extracts energy from a waste heat stream from a power source that would otherwise be wasted, such as an exhaust air stream 54 from an internal combustion engine 52. As shown at FIG. 1, a vehicle 50 employing the volumetric energy recovery device 20 is shown that returns the extracted energy back to the engine 52 via an output shaft 38 of the device 20. In one embodiment, a variable drive system 19 is utilized to transfer energy between the output shaft 38 and a power input location (e.g. via shaft 90) of the engine 52, such as the engine drive shaft. Accordingly, the volumetric energy recovery device 20 operates to increase the overall efficiency of the engine 52.

In some embodiments, an intermediate working fluid 12-1 is utilized to transfer energy between the engine exhaust and the device 20. Referring to FIG. 12, a system 10 is schematically presented in which the working fluid 12-1 is utilized in a Rankine cycle. Generally, the Rankine cycle uses a working substance, typically a fluid, in a closed loop to operate power generation systems and heat engines for converting thermal energy to mechanical work. In the Rankine cycle a heat “source” generates thermal energy that brings the working substance to an elevated temperature state. The working substance generates work in the “working body” of the heat engine while transferring thermal energy to the colder “sink” until the working substance reaches the lower temperature state. During this process, some of the thermal energy is converted into mechanical work by exploiting the properties of the working substance.

As shown schematically at FIG. 12, the system 10 can also employ a working fluid 12 as the working substance for closed loop circulation while using the Rankine cycle to generate mechanical work. The system 10 includes a condenser 14 configured to compress or condense the working fluid 12. The system 10 also includes a fluid pump 16. The pump 16 is configured to receive the working fluid 12 from the condenser 14 and pressurize the condensed working fluid 12. The system 10 also includes a heat exchanger 18. The heat exchanger 18 is configured to receive the working fluid 12 from the pump 16 and boil the working fluid. The system 10 additionally includes a volumetric rotary expansion device or expander 20. The expander 20 is configured to receive the working fluid 12 from the heat exchanger 18, generate the work, and complete the loop in the Rankine cycle by transferring the working fluid back to the condenser 14.

### Volumetric Energy Recovery Device—General

In general, the volumetric energy recovery device 20 relies upon the kinetic energy and static pressure of a working fluid to rotate an output shaft 38. Where the device 20 is used in an expansion application, such as with a Rankine cycle, additional energy is extracted from an intermediate working fluid 12-1 via fluid expansion. Also, the expander 20 may be an energy recovery device 20 wherein the working fluid 12-1 is the direct engine exhaust from the engine, as described in U.S. Patent Application No. 61/787,834, filed Mar. 15, 2013, which is incorporated herein by reference in its entirety. In such instances, device 20 may be referred to as an expander or expansion device, as so presented in the following paragraphs.

The expansion device 20 has a housing 22 with a fluid inlet 24 and a fluid outlet 26 through which the working fluid 12-1 undergoes a pressure drop to transfer energy to the output shaft 38. The output shaft 38 is driven by synchronously connected first and second interleaved counter-rotating rotors 30, 32 which are disposed in a cavity 28 of the housing 22. Each of the rotors 30, 32 has lobes that are twisted or helically disposed along the length of the rotors 30, 32. Upon rotation of the rotors 30, 32, the lobes at least partially seal the working fluid 12-1 against an interior side of the housing at which point expansion of the working fluid 12-1 only occurs to the extent allowed by leakage which represents and inefficiency in the system. In contrast to some expansion devices that change the volume of the working fluid when the fluid is sealed, the volume defined between the lobes and the interior side of the housing 22 of device 20 is constant as the working fluid 12-1 traverses the length of the rotors 30, 32. Accordingly, the expansion device 20 may be referred to as a “volumetric device” as the sealed or partially sealed working fluid volume does not change.

The expander 20 is shown in detail in FIGS. 2 and 3. In the particular embodiment shown at FIGS. 2 and 3, the expander 20 inlets and outlets are configured for use with a relatively low pressure working fluid, such as exhaust from an internal combustion engine or fuel cell. However, the following description is generally applicable for use with any type of a working fluid. The expander 20 includes a housing 22. As shown in FIG. 2, the housing 22 includes an inlet port 24 configured to admit relatively high-pressure working fluid 12-1 from the heat exchanger 18 (shown in FIG. 12). The housing 22 also includes an outlet port 26 configured to discharge working fluid 12-2 to the condenser 14 (shown in FIG. 12). It is noted that the working fluid discharging from the outlet 26 is at a relatively higher pressure than the pressure of the working fluid at the condenser 14. Referring to FIG. 8, the inlet and outlet ports 24, 26 may be provided with connectors 25, 27, respectively, for providing a fluid tight seal with other system components to ensure the working fluid 12-1, 12-2, which may be ethanol, does not dangerously leak outside of the expander 20.

As additionally shown in FIG. 3, each rotor 30, 32 has four lobes, 30-1, 30-2, 30-3, and 30-4 in the case of the rotor 30, and 32-1, 32-2, 32-3, and 32-4 in the case of the rotor 32. Although four lobes are shown for each rotor 30 and 32, each of the two rotors may have any number of lobes that is equal to or greater than two, as long as the number of lobes is the same for both rotors. Accordingly, when one lobe of the rotor 30, such as the lobe 30-1 is leading with respect to the inlet port 24, a lobe of the rotor 32, such as the lobe 30-2, is trailing with respect to the inlet port 24, and, therefore with respect to a stream of the high-pressure working fluid 12-1.

As shown, the first and second rotors 30 and 32 are fixed to respective rotor shafts, the first rotor being fixed to an output shaft 38 and the second rotor being fixed to a shaft 40. Each of the rotor shafts 38, 40 is mounted for rotation on a set of bearings (not shown) about an axis X1, X2, respectively. It is noted that axes X1 and X2 are generally parallel to each other. The first and second rotors 30 and 32 are interleaved and continuously meshed for unitary rotation with each other. With renewed reference to FIG. 2, the expander 20 also includes meshed timing gears 42 and 44, wherein the timing gear 42 is fixed for rotation with the rotor 30, while the timing gear 44 is fixed for rotation with the rotor 32. The timing gears 42, 44 are configured to retain specified position of the rotors 30, 32 and prevent contact between the rotors during operation of the expander 20.

The output shaft 38 is rotated by the working fluid 12 as the working fluid undergoes expansion from the relatively high-pressure working fluid 12-1 to the relatively low-pressure working fluid 12-2. As may additionally be seen in both FIGS. 2 and 3, the output shaft 38 extends beyond the boundary of the housing 22. Accordingly, the output shaft 38 is configured to capture the work or power generated by the expander 20 during the expansion of the working fluid 12 that takes place in the rotor cavity 28 between the inlet port 24 and the outlet port 26 and transfer such work as output torque from the expander 20. Although the output shaft 38 is shown as being operatively connected to the first rotor 30, in the alternative the output shaft 38 may be operatively connected to the second rotor 32.

### Expander—Geometry

In one aspect of the geometry of the expander 20, each of the rotor lobes 30-1 to 30-4 and 32-1 to 32-4 has a lobe geometry in which the twist of each of the first and second rotors 30 and 32 is constant along their substantially matching length 34. As shown schematically at FIG. 9, one parameter of the lobe geometry is the helix angle HA. By way of definition, it should be understood that references hereinafter to “helix angle” of the rotor lobes is meant to refer to the helix angle at the pitch diameter PD (or pitch circle) of the rotors 30 and 32. The term pitch diameter and it's identification are well understood to those skilled in the gear and rotor art and will not be further discussed herein. As used herein, the helix angle HA can be calculated as follows: Helix Angle (HA)=(180/.pi.* arctan (PD/Lead)), wherein: PD=pitch diameter of the rotor lobes; and Lead=the lobe length required for the lobe to complete 360 degrees of twist. It is noted that the Lead is a function of the twist angle and the length L1, L2 of the lobes 30, 32, respectively. The twist angle is known to those skilled in the art to be the angular displacement of the lobe, in degrees, which occurs in “traveling” the length of the lobe from the rearward end of the rotor to the forward end of the rotor. As shown, the twist angle is about 120 degrees, although the twist angle may be fewer or more degrees, such as 160 degrees.

In another aspect of the expander geometry, the inlet port 24 includes an inlet angle 24-1, as can be seen schematically at FIG. 2, and in the embodiment shown at FIG. 7. It is noted that the he expander inlet and outlet shown at FIGS. 7 and 8 are configured with compression fittings for a relatively high pressure working fluid, such as an organic solvent used in an Rankine cycle. However, the following description is generally applicable regardless of the working fluid used in the expander 20. In one embodiment, the inlet angle 24-1 is defined as the general or average angle of an inner surface 24a of the inlet port 24, for example an anterior inner surface as shown at FIG. 8. In one embodiment, the inlet angle 24-1 is defined as the angle of the general centerline of the inlet port 24, for example as shown at FIG. 2. In one embodiment, the inlet angle 24-1 is defined as the general resulting direction of the working fluid 12-1 entering the rotors 30, 32 due to contact with the anterior inner surface 24a, as can be seen at both FIGS. 2 and 8. As shown, the inlet angle 24-1 is neither perpendicular nor parallel to the rotational axes X1, X2 of the rotors 30, 32. Accordingly, the anterior inner surface 24a of the inlet port 24 causes a substantial portion of the working fluid 12-1 to be shaped in a direction that is at an oblique angle with respect to the rotational axes X1, X2 of the rotors 30, 32, and thus generally parallel to the inlet angle 24-1.

Furthermore, and as shown at both FIGS. 2 and 8, the inlet port 24 may be shaped such that the working fluid 12-1 is directed to the first axial ends 30a, 30b of the rotors 30, 32 and directed to the rotor lobe leading and trailing surfaces (discussed below) from a lateral direction. However, it is to be understood that the inlet angle 24-1 may be generally parallel or generally perpendicular to axes X1, X2, although an efficiency loss may be anticipated for certain rotor configurations. Furthermore, it is noted that the inlet port 24 may be shaped to narrow towards the inlet opening 24b, as shown in both FIGS. 2 and 8. Referring to FIG. 10, it can be seen that the inlet port 24 has a width W that is slightly less than the combined diameter distance of the rotors 30, 32. The combined rotor diameter is equal to the distance between the axes X1 and X2 plus the twice the distance from the centerline axis X1 or X2 to the tip of the respective lobe. In some embodiments, width W is the same as or more than the combined rotor diameter.

In another aspect of the expander geometry, the outlet port 26 includes an outlet angle 26-1, as can be seen schematically at FIG. 2, and in the embodiment shown at FIG. 7. In one embodiment, the outlet angle 26-1 is defined as the general or average angle of an inner surface 26a of the outlet port 26, for example as shown at FIG. 8. In one embodiment, the outlet angle 26-1 is defined as the angle of the general centerline of the outlet port 26, for example as shown at FIG. 2. In one embodiment, the outlet angle 26-1 is defined as the general resulting direction of the working fluid 12-2 leaving the rotors 30, 32 due to contact with the inner surface 26a, as can be seen at both FIGS. 2 and 8. As shown, the outlet angle 26-1 is neither perpendicular nor parallel to the rotational axes X1, X2 of the rotors 30, 32. Accordingly, the inner surface 26a of the outlet port 26 receives the leaving working fluid 12-2 from the rotors 30, 32 at an oblique angle which can reduce backpressure at the outlet port 26. In one embodiment, the inlet angle 24-1 and the outlet angle 26-1 are generally equal or parallel, as shown in FIG. 2. In one embodiment, the inlet angle 24-1 and the outlet angle 26-1 are oblique with respect to each other. It is to be understood that the outlet angle 26-1 may be generally perpendicular to axes X1, X2, although an efficiency loss may be anticipated for certain rotor configurations. It is further noted that the outlet angle 26-1 may be perpendicular to the axes X1, X2. As configured, the orientation and size of the outlet port 26-1 are established such that the leaving working fluid 12-2 can evacuate each rotor cavity 28 as easily and rapidly as possible so that backpressure is reduced as much as possible. The output power of the shaft 38 is maximized to the extent that backpressure caused by the outlet can be minimized such that the working fluid can be rapidly discharged into the lower pressure working fluid at the condenser.

The efficiency of the expander 20 can be optimized by coordinating the geometry of the inlet angle 24-1 and the geometry of the rotors 30, 32. For example, the helix angle HA of the rotors 30, 32 and the inlet angle 24-1 can be configured together in a complementary fashion. Because the inlet port 24 introduces the working fluid 12-1 to both the leading and trailing faces of each rotor 30, 32, the working fluid 12-1 performs both positive and negative work on the expander 20.

To illustrate, FIG. 3 shows that lobes 30-1, 30-4, 32-1, and 32-2 are each exposed to the working fluid 12-1 through the inlet port opening 24b. Each of the lobes has a leading surface and a trailing surface, both of which are exposed to the working fluid at various points of rotation of the associated rotor. The leading surface is the side of the lobe that is forward most as the rotor is rotating in a direction R1, R2 while the trailing surface is the side of the lobe opposite the leading surface. For example, rotor 30 rotates in direction R1 thereby resulting in side 30-1a as being the leading surface of lobe 30-1 and side 30-1b being the trailing surface. As rotor 32 rotates in a direction R2 which is opposite direction R1, the leading and trailing surfaces are mirrored such that side 32-2a is the leading surface of lobe 32-2 while side 32-2b is the trailing surface.

In generalized terms, the working fluid 12-1 impinges on the trailing surfaces of the lobes as they pass through the inlet port opening 24b and positive work is performed on each rotor 30, 32. By use of the term positive work, it is meant that the working fluid 12-1 causes the rotors to rotate in the desired direction: direction R1 for rotor 30 and direction R2 for rotor 32. As shown, working fluid 12-1 will operate to impart positive work on the trailing surface 32-2b of rotor 32-2, for example on surface portion 47. The working fluid 12-1 is also imparting positive work on the trailing surface 30-4b of rotor 30-1, for example of surface portion 46. However, the working fluid 12-1 also impinges on the leading surfaces of the lobes, for example surfaces 30-1 and 32-1, as they pass through the inlet port opening 24b thereby causing negative work to be performed on each rotor 30, 32. By use of the term negative work, it is meant that the working fluid 12-1 causes the rotors to rotate opposite to the desired direction, R1, R2.

Accordingly, it is desirable to shape and orient the rotors 30, 32 and to shape and orient the inlet port 24 such that as much of the working fluid 12-1 as possible impinges on the trailing surfaces of the lobes with as little of the working fluid 12-1 impinging on the on the leading lobes such that the highest net positive work can be performed by the expander 20.

One advantageous configuration for optimizing the efficiency and net positive work of the expander 20 is a rotor lobe helix angle HA of about 35 degrees and an inlet angle 24-1 of about 30 degrees. Such a configuration operates to maximize the impingement area of the trailing surfaces on the lobes while minimizing the impingement area of the leading surfaces of the lobes. In one embodiment, the helix angle is between about 25 degrees and about 40 degrees. In one embodiment, the inlet angle 24-1 is set to be within (plus or minus) 15 degrees of the helix angle HA. In one embodiment, the helix angle is between about 25 degrees and about 40 degrees. In one embodiment, the inlet angle 24-1 is set to be within (plus or minus) 15 degrees of the helix angle HA. In one embodiment, the inlet angle is within (plus or minus) 10 degrees of the helix angle. In one embodiment, the inlet angle 24-1 is set to be within (plus or minus) 5 degrees of the helix angle HA. In one embodiment, the inlet angle 24-1 is set to be within (plus or minus) fifteen percent of the helix angle HA while in one embodiment, the inlet angle 24-1 is within ten percent of the helix angle. Other inlet angle and helix angle values are possible without departing from the concepts presented herein. However, it has been found that where the values for the inlet angle and the helix angle are not sufficiently close, a significant drop in efficiency (e.g. 10-15% drop) can occur.

### Variable Drive System

As identified previously, the variable drive system 19 is shown at FIGS. 1 and 11-12. In some operational modes, there is not a direct match between the output of the expander output shaft 38 and the operational state of the engine 52. For example, it may not be desired to apply the full shaft power developed by the expander output shaft 38 to the engine 52. Another example is that the expander 20 can become a parasitic loss on the engine 52 when the output at the shaft 38 is sufficiently low, such as is the case at engine idle when exhaust gas volumes are relatively low.

Accordingly, a variable drive system 19 can be provided to minimize the energy losses that might occur as a result from these conditions. As configured, the variable drive system 19 can direct power from the engine 52 to the energy storage device 60 instead of losing the power by reverse driving the expander shaft 38. Also, the variable drive system 19 can direct power developed by the expander 20 that is not needed by the engine 52 to an energy storage device 60.

Where recaptured power is transferred from the expander to the engine 52, the recaptured power is immediately reused by the engine 52. Where recaptured power is delivered to the load storage device 60, the stored work generated by the engine 52 or the expander 20 may be accumulated for subsequent release on demand. Load storage device 60 may be an accumulator wherein the recovery device 20 provides shaft power to a pump 70. Alternatively, load storage device 60 may be a battery which stores electrical energy from a generator 70 that is driven by the variable drive system 19.

With reference to FIGS. 1 and 11-12, the variable drive system is shown as a compound planetary gear set structure having a common or shared carrier member. Such a compound planetary gear set may provide a variable gear ratio configured to substantially match the speeds of the engine 52 and the shaft 38 depending on the operating conditions experienced by the engine 52. As shown, the variable drive system 19 couples the output shaft 38 of the expander 20 with a shaft 90 that is mechanically coupled to the engine 52 (e.g. via a belt and pulley). The variable drive system 19 further couples the shaft of a pump or generator 70 to the shaft 38 and the shaft 90.

In one embodiment, the shaft 38 can be coupled to a sun gear 80 of the planetary gear set, while shaft 90 can be coupled to a carrier 86 that is connected to a set of planet gears 82 that are rotationally engaged with the sun gear 80. A ring gear 84 is also provided that is shown as being rotationally engaged with the planet gears 82. When the position of the ring gear 84 is fixed, all power from the shaft 38 is transmitted to the shaft 90 at a first gear ratio defined by the sun gear 80 and the planetary gears 84. Where the ring gear 84 is allowed to rotate, slip power can be transmitted from shaft 90 to the ring gear 84 via the carrier 76 and planet gears 82. Such a configuration allows for the shaft 90 to send power to the ring gear 84 in the event that the expander shaft 38 is unable to contribute positive work to the shaft 90. Where the pump/generator 70 allows the ring gear 84 to spin freely, no power is transferred between the shafts 38, 90. It is also possible to provide a one way bearing to prevent the engine 52 from driving the expander 20 to allow 72 or 70 to freewheel such that no negative torque is applied to the expander 20.

With reference to FIGS. 1 and 11-12, the generator or pump 70 may be placed in operative connection with the ring gear 84 via a gear 72 having teeth 72a that interface with teeth 84b on the ring gear 84. Other types of drive systems are also possible between the ring gear 84 and the pump/generator 70, such as a belt and pulley. Similarly, the sun gear 80 has teeth 80a that rotationally engage with corresponding teeth 82a on the planet gears 82. The planet gear teeth 82a also rotationally engage with corresponding teeth 84a on the ring gear 84.

Also, the sun gear 80 has an opening 80b for engaging with the shaft 38 while a carrier member 86 that is connected to each of the planet gears 82 has an opening 86a for engaging with the shaft 90. Accordingly, when shaft 38 is rotated, the sun gear 80 causes the planet gears 82 to rotate. As the planet gears 82 are connected to the carrier, the planet gears 82 cause the carrier 86 to rotate which in turn drives rotation of shaft 90. As stated previously, all power is transmitted from shaft 38 to shaft 90 if the ring gear 84 position is fixed. Likewise, where the shaft 38 is fixed, all power is transferred between shaft 90 and the ring gear 84. Furthermore, when the expander 20 is permitted to freewheel because zero braking is being provided by the pump/generator 70, parasitic drag may be reduced, i.e., minimized, to increase operating efficiency of the entire system.

### System Control and Operation

Any of the systems shown in FIGS. 1, 5-6, and 12 may be operated through a control system. Such a system is presented at FIG. 1 which shows an electronic controller. The electronic controller 500 is schematically shown as including a processor 500A and a non-transient storage medium or memory 500B, such as RAM, a flash drive or a hard drive. Memory 500B is for storing executable code, the operating parameters, and the input from the operator user interface 500D, while processor 500A is for executing the code. The electronic controller is also shown as including a transmitting/receiving port 500C, such as a vehicle CAN bus. A user interface 500D may also be provided to activate and deactivate the system, allow a user to manipulate certain settings or inputs to the controller 500, and to view information about the system operation.

The electronic controller 500 typically includes at least some form of memory 500B. Examples of memory 500B include computer readable media. Computer readable media includes any available media that can be accessed by the processor 500A. By way of example, computer readable media includes computer readable storage media and computer readable communication media.

Computer readable storage media includes volatile and nonvolatile, removable and non-removable media implemented in any device configured to store information such as computer readable instructions, data structures, program modules, or other data. Computer readable storage media includes, but is not limited to, random access memory, read only memory, electrically erasable programmable read only memory, flash memory or other memory technology, compact disc read only memory, digital versatile disks or other optical storage, magnetic cassettes, magnetic tape, magnetic disk storage or other magnetic storage devices, or any other medium that can be used to store the desired information and that can be accessed by the processor 500A.

Computer readable communication media typically embodies computer readable instructions, data structures, program modules or other data in a modulated data signal such as a carrier wave or other transport mechanism and includes any information delivery media. The term “modulated data signal” refers to a signal that has one or more of its characteristics set or changed in such a manner as to encode information in the signal. By way of example, computer readable communication media includes wired media such as a wired network or direct-wired connection, and wireless media such as acoustic, radio frequency, infrared, and other wireless media. Combinations of any of the above are also included within the scope of computer readable media.

Electronic controller 500 is also shown as having a number of inputs/outputs that may be used for implementing desired operational modes of the system 10. For example, electronic controller 500 provides outputs for commanding an expander bypass valve 202 and for controlling the variable drive system 19 (e.g. activating and deactivating generator or pump 70). Referring to FIG. 1, an exhaust bypass line 54a and valve 202 are provided to allow exhaust gases to be diverted around the energy recovery device 20, when desired. Likewise, electronic controller 500 receives inputs for the control of the system 10, for example an input from pressure sensor 206 upstream of the expansion device 20, an input from pressure sensor 208 downstream of the expansion device, and various other inputs via the vehicle CAN bus. It is also noted that the above described components of controller 500 may simply be implemented as part of the primary vehicle operating system controller and is not necessarily a separate controller.

In operation, the expander bypass valve 202 can be controlled to maintain a pressure differential set point across the expansion device 20, as measured by the difference between the pressure signals received from sensors 206 and 208. The pressure differential across the expansion device 20 directly corresponds to the torque produced by the expansion device 20. Additionally, the operation of the expander bypass valve 202 allows for the backpressure on the power plant exhaust to be controlled such that excessive backpressure is not caused by the expansion device 20 which could result in significant efficiency reductions for the power plant 16. The variable drive system 19, via activation of the pump or generator 70, can also be adjusted to prevent excessive back pressure from developing in the exhaust system 54, instead of or in conjunction with the expander bypass valve 202.

### Rankine Cycle Operation

FIG. 4 shows a diagram 48 depicting a representative Rankine cycle applicable to the system 10, as described with respect to FIG. 12. The diagram 48 depicts different stages of the Rankine cycle showing temperature in Celsius plotted against entropy “S”, wherein entropy is defined as energy in kilojoules divided by temperature in Kelvin and further divided by a kilogram of mass (kJ/kg*K). The Rankine cycle shown in FIG. 4 is specifically a closed-loop Organic Rankine Cycle (ORC) that may use an organic, high molecular mass working fluid, with a liquid-vapor phase change, or boiling point, occurring at a lower temperature than the water-steam phase change of the classical Rankine cycle. Accordingly, in the system 10, the working fluid 12 may be a solvent, such as ethanol, n-pentane or toluene.

In the diagram 48 of FIG. 4, the term “\dot{Q}” represents the heat flow to or from the system 10, and is typically expressed in energy per unit time. The term “\dot{W} ” represents mechanical power consumed by or provided to the system 10, and is also typically expressed in energy per unit time. As may be additionally seen from FIG. 4, there are four distinct processes or stages 48-1, 48-2, 48-3, and 48-4 in the ORC. During stage 48-1, the working fluid 12 in the form of a wet vapor enters and passes through the condenser 14, in which the working fluid is condensed at a constant temperature to become a saturated liquid. Following stage 48-1, the working fluid 12 is pumped from low to high pressure by the pump 16 during the stage 48-2. During stage 48-2, the working fluid 12 is in a liquid state.

From stage 48-2 the working fluid is transferred to stage 48-3. During stage 48-3, the pressurized working fluid 12 enters and passes through the heat exchanger 18 where it is heated at constant pressure by an external heat source to become a two-phase fluid, i.e., liquid together with vapor. From stage 48-3 the working fluid 12 is transferred to stage 48-4. During stage 48-4, the working fluid 12 in the form of the two-phase fluid expands through the expander 20, generating useful work or power. The expansion of the partially vaporized working fluid 12 through the expander 20 decreases the temperature and pressure of the two-phase fluid, such that some additional condensation of the two-phase working fluid 12 may occur. Following stage 48-4, the working fluid 12 is returned to the condenser 14 at stage 48-1, at which point the cycle is then complete and will typically restart.

Typically a Rankine cycle employs a turbine configured to expand the working fluid during the stage 48-4. In such cases, a practical Rankine cycle additionally requires a superheat boiler to take the working fluid into superheated range in order to remove or evaporate all liquid therefrom. Such an additional superheating process is generally required so that any liquid remaining within the working fluid will not collect at the turbine causing corrosion, pitting, and eventual failure of the turbine blades. As shown, the ORC of FIG. 4 is characterized by the absence of such a superheat boiler and the attendant superheating process needed to evaporate all liquid from the working fluid. Such a cycle may also be representative of a system or engine at low idling speed where superheat is not generated due to low power plant output. The preceding omission is permitted by the fact that the expander 20 is configured as a twin interleafed rotor device which is not detrimentally impacted by the presence of a liquid in the working fluid 12. Furthermore, the expander 20 benefits from the presence of such a liquid, primarily because the remaining liquid tends to enhance the operational efficiency of the expander by sealing clearances between the first and second rotors 30, 32, and between the rotors and the housing 22. Accordingly, when useful work is generated by the expander 20 in the system 10, the working fluid 12 within the expander is present in two phases, i.e., as a liquid-vapor, such that conversion efficiency of the ORC is increased. However, it is to be understood that the recovery device 20 can be used in configurations involving a superheated gas.

As shown in FIG. 5, the system 10 of FIG. 12 may be used in a vehicle 50 having an internal combustion (IC) engine 52 as a vehicle power-plant. As shown, the IC engine 52 includes an exhaust system 54. The exhaust system 54 may further include an exhaust gas recirculation (EGR) feature. According to the present disclosure, the EGR of the exhaust system 54 may operate as the heat exchanger 18 of the Rankine cycle of the system 10. Additionally, as shown in FIG. 6, the system 10 may be used in a vehicle 56 that includes a fuel cell 58 such as a solid oxide fuel cell configured to operate as the vehicle power-plant.

The detailed description and the drawings or figures are supportive and descriptive of the invention, but the scope of the invention is defined solely by the claims. While some of the best modes and other embodiments for carrying out the claimed invention have been described in detail, various alternative designs and embodiments exist for practicing the invention defined in the appended claims.

1. An energy recovery system:
(a) a power source that generates a waste heat stream, the power source having a power input location;
(b) a volumetric energy recovery device configured to transfer energy from the waste heat stream to the power input location, the volumetric energy recovery device including:
(c) a housing having an inlet port and an outlet port;
(d) first and second twisted meshed rotors in fluid communication with the inlet and outlet ports, the rotors being rotatably disposed in the housing wherein a first rotational axis of the first twisted rotor is parallel to a second rotational axis of the second twisted rotor;
(e) a first output shaft operatively connected to one of the first and second rotors and to the power input location of the power source, the output shaft being rotated by power from the waste heat stream; and
(f) a variable speed drive system connected to the first output shaft, the variable speed drive system being configured to transfer rotational energy from the first output shaft to an output shaft associated with the power source and to one of a pump and a generator.

2. The energy recovery system of claim 1, wherein the power source is an internal combustion engine and the waste heat stream is an engine exhaust stream.

3. The energy recovery system of claim 1, wherein the waste heat stream is in thermal communication with a working fluid and wherein the working fluid is in fluid communication with the volumetric energy recovery device via the inlet and outlet ports.

4. The energy recovery system of claim 3, wherein the working fluid is an organic fluid.

5. The energy recovery system of claim 4, wherein the working fluid is subjected to a Rankine cycle in which at least a portion of the working fluid is expanded from a liquid state to a vapor state within the energy recovery device.

6. The energy recovery system of claim 1, wherein the one of a generator and a pump is in communication with a load storage device.

7. The energy recovery system of claim 1, wherein the load storage device is a fuel cell.

8. The energy recovery system of claim 1, wherein the load storage device is an accumulator.

9. A system used to generate useful work via a closed-loop Rankine cycle, the system comprising:
(a) a vehicle engine configured to generate an exhaust gas stream;
(b) a condenser configured to condense a working fluid;
(c) a fluid pump configured to pressurize the working fluid;
(d) a heat exchange configured to transfer heat from the exhaust gas stream to the working fluid; and
(e) a volumetric fluid expander having first and second twisted mesh rotors configured to be driven by the condensed, pressurized, and heated working fluid, the expander having a first output shaft connected operatively connected to one of the first and second rotors; and
(f) a variable speed drive system connected to the first output shaft, to a second output shaft in power communication with the vehicle engine and in communication with one of a generator and a pump.

10. The system of claim 9, wherein the variable speed drive system includes a planetary gear set having a sun gear, a ring gear, and a plurality of planet gears between the sun and ring gears.

11. The system of claim 10, wherein the sun gear is coupled to the first output shaft, the planet gears are coupled to the second output shaft, and the generator or pump is coupled to the ring gear.

12. The system of claim 9, wherein the one of a generator and a pump is a generator in communication with a battery.

13. The system of claim 9, wherein the one of a generator and a pump is a pump in communication with an accumulator.

14. The system of claim 9, further comprising a load storage device, wherein the mechanical work generated by the expander is accumulated in the load storage device for subsequent release on demand.

15. The system of claim 14, wherein the load storage device is one of a pneumatic accumulator, a hydraulic accumulator, and an electric battery.
